(19) United States
(12) Patent Application Publication
(10) Pub. No.: US 2017/0047750 A1
(43) Pub. Date: Feb. 16, 2017

(54) Charging Assembly

(71) Applicants: Lateefa Mosley, Los Angeles, CA (US); Lakeetha Mosley, Los Angeles, CA (US); Latoya Creighton, Los Angeles, CA (US)

(72) Inventors: Lateefa Mosley, Los Angeles, CA (US); Lakeetha Mosley, Los Angeles, CA (US); Latoya Creighton, Los Angeles, CA (US)

(21) Appl. No.: 14/821,839

(22) Filed: Aug. 10, 2015

(51) Int. Cl. H02J 7/00

(52) U.S. Cl. CPC H02J 7/0042; H02J 7/0047; H02J 7/0052

(57) ABSTRACT

A charging assembly includes a plug that may be electrically coupled to a power source. A cord is coupled to and extends away from the plug. The cord may be electrically coupled to an extrinsic electronic device thereby facilitating the plug to charge the extrinsic electronic device. A control circuit is positioned within the plug. The control circuit is electrically coupled to the cord and the control circuit detects a charge level of the extrinsic electrical device. Thus, the control circuit ceases to charge the extrinsic electronic device when the extrinsic electronic device is fully charged.

### BACKGROUND OF THE DISCLOSURE

Field of the Disclosure

The disclosure relates to charging devices and more particularly pertains to a new charging device for ceasing to charge an extrinsic electronic device when the extrinsic electronic device is fully charged.

### SUMMARY OF THE DISCLOSURE

An embodiment of the disclosure meets the needs presented above by generally comprising a plug that may be electrically coupled to a power source. A cord is coupled to and extends away from the plug. The cord may be electrically coupled to an extrinsic electronic device thereby facilitating the plug to charge the extrinsic electronic device. A control circuit is positioned within the plug. The control circuit is electrically coupled to the cord and the control circuit detects a charge level of the extrinsic electrical device.

Thus, the control circuit ceases to charge the extrinsic electronic device when the extrinsic electronic device is fully charged.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a charging assembly according to an embodiment of the disclosure.

FIG. 2 is a left side view of an embodiment of the disclosure.

FIG. 3 is a front view of an embodiment of the disclosure.

FIG. 4 is a back view of an embodiment of the disclosure.

FIG. 5 is a schematic view of an embodiment of the disclosure.

### DESCRIPTION OF THE PREFERRED EMBODIMENT

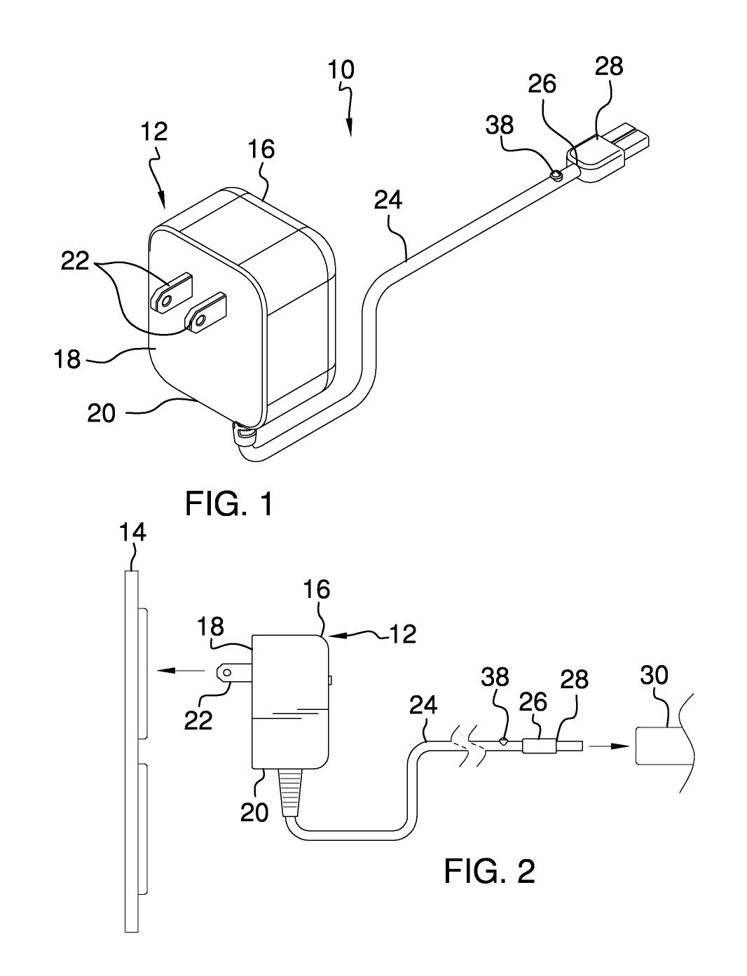

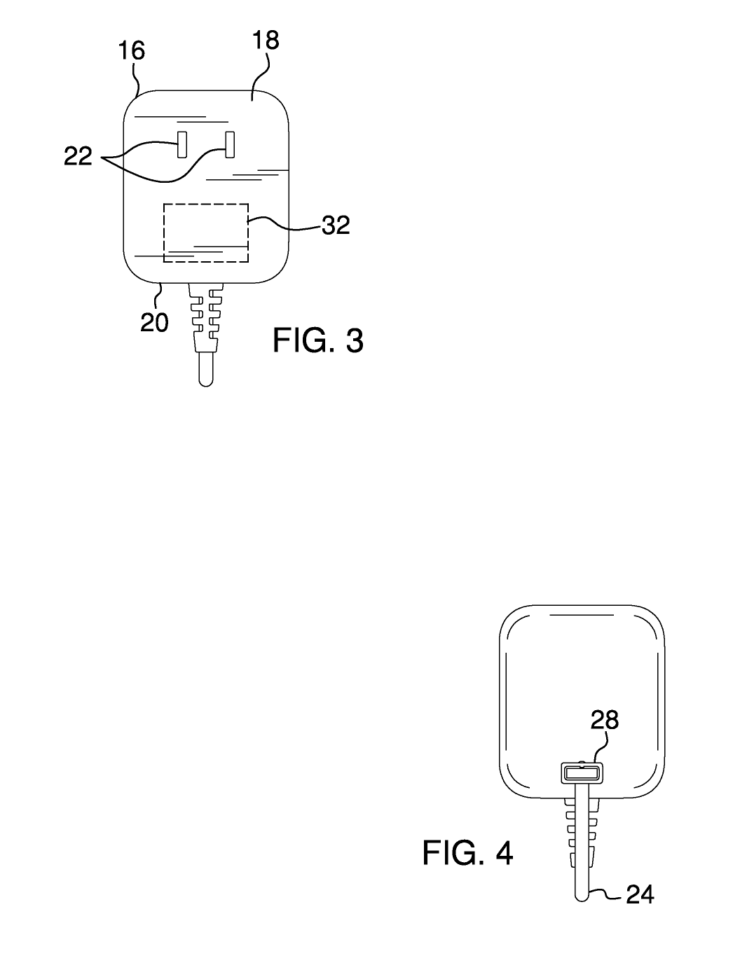

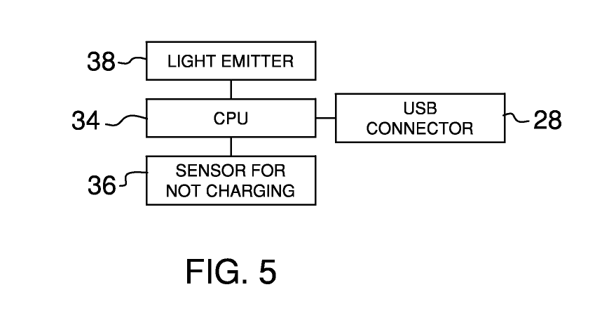

With reference now to the drawings, and in particular to FIGS. 1 through 5 thereof, a new charging device embodying the principles and concepts of an embodiment of the disclosure and generally designated by the reference numeral 10 will be described.

As best illustrated in FIGS. 1 through 5, the charging assembly 10 generally comprises a plug 12 that may be electrically coupled to a power source 14. The power source 14 may comprise an electrical outlet or the like. The plug 12 comprises a housing 16 that has a front side 18 and a bottom side 20. A pair of contacts 22 is provided and each of the contacts 22 extends away from the front side 18. Each of the contacts 22 may be electrically coupled to the power source 14.

A cord 24 is coupled to and extends away from the plug 12. The cord 24 is coupled to the bottom side 20 and the cord 24 has a distal end 26 with respect to the plug 12. The cord 24 is electrically coupled to the pair of contacts 22 and the distal end 26 has a coupler 28 that is coupled to the distal end 26. The coupler 28 may be electrically coupled to an extrinsic electronic device 30 thereby facilitating the plug 12 to charge the extrinsic electronic device 30. The coupler 28 may comprise a USB plug or the like and the extrinsic electronic device 30 may comprise a Smart Phone or the like.

A control circuit 32 is positioned within the plug 12. The control circuit 32 is electrically coupled between the contacts 22 and the cord 24. Thus, the control circuit 32 detects a charge level of the extrinsic electrical device 30. The control circuit 32 ceases charging the extrinsic electronic device 30 when the extrinsic electronic device 30 is fully charged. Thus, the extrinsic electronic device 30 is prevented from being damaged due to overcharging.

The control circuit 32 comprises a processor 34 that is positioned within the housing 16. The processor 34 is electrically coupled between the contacts 22 and the coupler 28. A charge sensor 36 is positioned within the housing 16 and the charge sensor 36 is electrically coupled to the processor 34. The charge detector 36 detects a level of charge of the extrinsic electronic device 30 and the processor 34 ceases charging the extrinsic electronic device 30 when the charge detector 36 senses the extrinsic electronic device 30 has reached a full charge.

A light emitter 38 is positioned on the cord 24 and the light emitter 38 is positioned adjacent to the distal end 26. The light emitter 38 is electrically coupled to the control circuit 32. Thus, the light emitter 38 emits light when the control circuit 32 is charging the extrinsic electronic device 30. The light emitter 38 may comprise an LED or the like.

In use, the plug 12 is electrically coupled to the power source 14 and the coupler 28 is electrically coupled to the extrinsic electronic device 30 when the extrinsic electronic device 30 needs to be charged. The light emitter 38 emits light while the extrinsic electronic device 30 is charging. The light emitter 38 ceases to emit light when the processor 34 ceases charging the extrinsic electronic device 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charging assembly comprising:
a plug being configured to be electrically coupled to a power source;
a cord being coupled to and extending away from said plug, said cord being configured to be electrically coupled to an extrinsic electronic device thereby facilitating said plug to charge the extrinsic electronic device,
a control circuit being positioned within said plug, said control circuit being electrically coupled to said cord wherein said control circuit is configured to detect a charge level of the extrinsic electrical device thereby facilitating said control circuit to cease charging the extrinsic electronic device when the extrinsic electronic device is fully charged.

2. The assembly according to claim 1, wherein said plug comprises:
a housing having a front side and a bottom side; and
a pair of contacts, each of said contacts extending away from said front side, each of said contacts being configured to be electrically coupled to the power source.

3. The assembly according to claim 2, wherein said cord is coupled to said bottom side, said cord having a distal end with respect to said plug, said cord being electrically coupled to said pair of contacts, said distal end having a coupler being coupled to said distal end.

4. The assembly according to claim 1, wherein said control circuit comprises a processor being positioned within said housing, said processor being electrically coupled between said contacts and said coupler.

5. The assembly according to claim 4, further comprising a charge sensor being positioned within said housing, said charge sensor being electrically coupled to said processor wherein said charge detector is configured to detect a level of charge of the extrinsic electronic device; and

6. The assembly according to claim 1, further comprising:
said cord having a distal end; and
a light emitter being positioned on said cord, said light emitter being positioned adjacent to said distal end, said light emitter being electrically coupled to said control circuit wherein said light emitter is configured to emit light when said control circuit is charging the extrinsic electronic device.

7. A charging assembly comprising:
a plug being configured to be electrically coupled to a power source, said plug comprising:
a housing having a front side and a bottom side, and
a pair of contacts, each of said contacts extending away from said front side, each of said contacts being configured to be electrically coupled to the power source;
a cord being coupled to and extending away from said plug, said cord being coupled to said bottom side, said cord having a distal end with respect to said plug, said cord being electrically coupled to said pair of contacts, said distal end having a coupler being coupled to said distal end, said coupler being configured to be electrically coupled to an extrinsic electronic device thereby facilitating said plug to charge the extrinsic electronic device,
a control circuit being positioned within said plug, said control circuit being electrically coupled between said contacts and said cord wherein said control circuit is configured to detect a charge level of the extrinsic electrical device thereby facilitating said control circuit to cease charging the extrinsic electronic device when the extrinsic electronic device is fully charged, said control circuit comprising:
a processor being positioned within said housing, said processor being electrically coupled between said contacts and said coupler, and
a charge sensor being positioned within said housing, said charge sensor being electrically coupled to said processor wherein said charge detector is configured to detect a level of charge of the extrinsic electronic device; and
a light emitter being positioned on said cord, said light emitter being positioned adjacent to said distal end, said light emitter being electrically coupled to said control circuit wherein said light emitter is configured to emit light when said control circuit is charging the extrinsic electronic device.
